(19) United States
(12) Patent Application Publication
(10) Pub. No.: US 2026/0303364 A1
(43) Pub. Date: Oct. 1, 2026

(54) Authenticated Message Delivery With Controlled Routing Gateway

(71) Applicant: Peter Bowers, Wernersville, PA (US)

(72) Inventor: Peter Bowers, Wernersville, PA (US)

(21) Appl. No.: 19/700,251

(22) Filed: Jun. 6, 2026

Related U.S. Application Data
(63) Continuation-in-part of application No. 18/922,375, filed on Oct. 21, 2024.
(60) Provisional application No. 63/591,747, filed on Oct. 19, 2023.

(51) Int. Cl. H04L 9/32; H04L 9/00

(52) U.S. Cl. CPC H04L 9/3247; H04L 9/3271; H04L 9/50; H04L 2209/56

(57) ABSTRACT

A system controls outbound electronic communications attributed to blockchain-verified senders. A verification service validates a cryptographic signature for a wallet address or public key, determines ownership or control of a blockchain-recorded asset or identity, and creates a verified sender record. A binding-record data store stores subscription binding records associating recipient identifiers with verified sender records and opt-in state. For a proposed outbound communication, a routing gateway service determines a current per-recipient authorization decision and, only for an allow decision, generates an authorization artifact bound to communication, recipient, channel, sender, binding, policy, and timing fields. A delivery adapter process validates the authorization artifact before retrieving or using transport credentials, creating payloads, writing queues, calling provider APIs, signing webhooks, resolving push tokens, writing inbox records, or opening network connections. Non-bypass controls and fresh retry authorization prevent unauthorized or stale transport invocation.

### CROSS-REFERENCE TO RELATED APPLICATIONS

This application is a continuation-in-part of U.S. patent application Ser. No. 18/922,375, filed Oct. 21, 2024. That application claims the benefit of U.S. Provisional Patent Application No. 63/591,747, filed Oct. 19, 2023. The contents of the foregoing applications are incorporated by reference in their entirety.

### TECHNICAL FIELD

The disclosure relates to authenticated electronic communication systems, blockchain-recorded sender identity and ownership verification, cryptographic sender verification, subscription and opt-in messaging, message routing gateways, delivery authorization, provider application programming interfaces (provider APIs), and controlled invocation of electronic delivery transports.

### BACKGROUND

Electronic communication systems may allow a sender to communicate with subscribers or recipients through email, application notifications, web interfaces, application programming interfaces, webhooks, in-platform inboxes, push-notification services, or other delivery channels. In some systems, a sender identity may be associated with cryptographic control of a wallet, public key, blockchain address, smart contract, token, non-fungible token, decentralized identifier, domain, or other blockchain-recorded asset or identity. A recipient may rely on that cryptographic control or ownership relationship when deciding whether communications attributed to the sender should be trusted or accepted.

Some conventional systems verify a sender or store subscription preferences, but still permit components that compose content to call delivery providers or provider APIs, write outbound queues, use cached credentials, sign webhook requests, write inbox rows, or otherwise cause recipient-visible outbound actions without a current per-recipient delivery authorization. If application components can bypass a registry or directly invoke delivery transports, a stored opt-in record or a past sender verification may not prevent unauthorized delivery when sender status, ownership state, endpoint status, channel policy, or recipient opt-in state changes.

A need exists for a technical architecture in which outbound communications attributed to a verified sender are routed through a controlled gateway, where transport authority is not available to non-gateway services and where a delivery adapter validates a current gateway authorization before the first transport-invocation action.

### SUMMARY

In some embodiments, the disclosed architecture may be used in distributed communication platforms in which multiple internal services may compose messages, schedule campaigns, manage retries or redrives, or otherwise participate in preparing outbound communications, and in which, absent gateway controls, such services may be able to write outbound queues, invoke provider APIs, resolve push tokens, sign webhook requests, use transport credentials, or otherwise cause recipient-visible outbound actions. In such platforms, prior sender verification or a stored opt-in record may be insufficient when a non-gateway service can bypass the routing gateway service or a current authorization decision and directly perform, or cause performance of, a transport-invocation action. The routing gateway service, authorization artifact generated only for an allow decision, delivery-adapter validation, fail-closed refusal, and non-bypass controls establish a technical delivery path in which recipient-visible transport-invocation actions are performed only after a current authorization decision is determined and the authorization artifact is generated and validated for the particular communication identifier, recipient identifier, channel type, verified sender identifier, binding identifier, and policy version.

In some embodiments, a system includes a verification service, a binding-record data store, a routing gateway service, one or more delivery adapter processes, and one or more policy or credential-control components. The verification service may include challenge-generation logic, signature-validation logic, and ownership-lookup logic. The verification service generates a cryptographic challenge for a wallet address or public key, receives a signature over the challenge, validates the signature, determines ownership or control of a blockchain-recorded asset or identity, and creates or updates a verified sender record when the validation and ownership or control determination satisfy a verification policy.

The binding-record data store stores subscription binding records. A subscription binding record may be keyed by at least a verified sender identifier and a recipient identifier, and may associate the recipient identifier with a verified sender record and an opt-in state. The subscription binding record may further include a binding identifier, subscriber identifier, channel type, policy version, endpoint status, opt-in evidence, unsubscribe status, revocation state, or other authorization-relevant state.

The routing gateway service forms a controlled outbound path for communications attributed to verified senders. The routing gateway service receives a proposed outbound communication associated with a verified sender record and a recipient identifier. The routing gateway service determines a current authorization decision for the recipient identifier based on at least the verified sender record, the subscription binding record, the opt-in state, a channel type, and a policy version. Only when the current authorization decision is an allow decision does the routing gateway service generate an authorization artifact and provide the authorization artifact to a delivery adapter process.

The authorization artifact may comprise a signed authorization token, a gateway-generated authorization decision identifier, a signed queue envelope, a stored authorization-decision reference, a policy-decision reference, a message attribute, a service-mesh identity assertion, or another artifact that permits the delivery adapter process to confirm that the routing gateway service generated an allow decision for the particular communication, recipient, channel, sender, binding, and policy version. The authorization artifact may be bound to one or more of a communication identifier, recipient identifier, channel type, verified sender identifier, binding identifier, policy version, issued-at time, expiration time, nonce, replay-protection value, selected delivery adapter identifier, provider account identifier, provider endpoint identifier, queue identifier, provider tenant, or delivery authority scope.

The delivery adapter process validates the authorization artifact before retrieving a transport credential, using a cached transport credential, creating a channel payload, writing an outbound queue entry, calling a provider application programming interface (provider API), writing to an inbox store, signing a webhook request, resolving a push token, or opening an outbound network connection. If the authorization artifact is absent, expired, replayed, stale, associated with a non-allow decision, or mismatched to the communication, recipient, channel, verified sender, selected adapter, provider account, provider endpoint, queue, or delivery authority scope to which the artifact is bound, the adapter refrains from performing the transport-invocation action.

The system may enforce non-bypass controls that prevent non-gateway service identities from retrieving or using transport credentials and from reaching endpoints of delivery adapter processes. The non-bypass controls may include credential-store access policies, credential-use policies, gateway-owned queues, queue writer policies, adapter endpoint access policies, network access controls, service-mesh policies, mutual-TLS service-identity rules, role-based access-control rules, egress policies, private subnet restrictions, provider-account segmentation, or combinations thereof.

In some embodiments, a failed or incomplete outbound communication is not replayed using stale authority. A retry queue or dead-letter queue may store a queue item associated with a communication identifier, a recipient identifier, and an initial authorization artifact used for a first delivery attempt. The routing gateway service may mark the initial authorization artifact as replay-ineligible and require a new authorization decision and a fresh authorization artifact before a replay or redrive request can cause a delivery adapter process to perform a transport-invocation action.

### BRIEF DESCRIPTION OF THE DRAWINGS

FIG. 1 illustrates an authenticated message delivery system 100 including a sender client 102, subscriber or recipient client 104, verification service 110, binding-record data store or subscription registry 120, message composition or submission interface 130, non-gateway service 132, routing gateway service 140, gateway-controlled outbound queue 146, delivery adapter processes 150, audit log 160, policy or credential store 170, external blockchain network 180, and non-bypass enforcement boundary 190.

FIG. 2 illustrates sender verification and verified sender record creation 200 using a sender client or wallet 102, verification service 110, external blockchain network 180, verified sender record 122, audit log 160, and verification steps including receiving a verification request 202, generating a challenge 204, returning the challenge 206, receiving a signed challenge 208, validating the signature 210, querying blockchain ownership or control 212, determining whether ownership or control is verified 214, creating or updating the verified sender record 216, storing expiry, policy version, and audit data 218, and rejecting invalid or incomplete verification paths 220, 222, 224, 226.

FIG. 3 illustrates subscriber opt-in and subscription binding record creation 300 using a subscriber or recipient client 104, verified sender record 122, binding-record data store 120, subscriber identifier record 124, recipient identifier record 126, opt-in state or consent record 128, subscription binding record 129, audit log 160, opt-in and validation steps 302, 304, 306, 308, record-creation steps 310, 312, 314, 316, active-binding logging step 318, rejection steps 320, 322, and unsubscribe, recipient-revocation, or sender-state-change processing step 324.

FIG. 4 illustrates delivery-time authorization and adapter-side validation 400 of an authorization artifact before transport-invocation actions, including sender client or sender service 102, binding-record data store 120, delivery adapter process 150, audit log 160, policy or credential store 170, subscriber or recipient client 104, gateway authorization processing steps 402, 404, 406, 408, 410, 412, 414, 416, adapter validation step 418, validated pre-transport actions 419, audit storage step 420, and non-allow handling step 424.

FIG. 5 illustrates fail-closed refusal 500 of transport invocation when an authorization artifact or authorization decision is absent, expired, replayed, mismatched, stale, or non-allow, including sender client or sender API service 102, binding-record data store 120, verified sender state 122, binding, opt-in, or endpoint state 129, allowed delivery flow 400, delivery adapter process 150, audit log 160, policy or credential store 170, refusal processing steps 502, 504, 506, 508, 510, blocked pre-transport actions 512, blocked-decision record 518, rejection reasons 520, and optional sender notice 524.

FIG. 6 illustrates structural non-bypass enforcement 600 using non-gateway services 602, inbound proposed communication queue 604, routing gateway service 140, signed token or decision identifier 606, gateway-owned outbound queue 608, adapter endpoint controls 610, delivery adapter process 150, adapter artifact validation 612, provider or recipient transport channel 614, queue rejection 616, blocked bypass attempt event 620, policy or credential store 170, audit log 160, credential-store access policy, gateway-owned queue controls, adapter endpoint access controls, service-mesh rules, mutual-TLS identity rules, role-based access controls, and audit logging.

FIG. 7 illustrates retry and dead-letter handling 700 in which a first delivery attempt 702 stores a failed item in a retry queue or dead-letter queue 704, a replay or redrive request is received at a gateway 706 within a gateway-authorized redrive path 726, current delivery authorization state is rechecked 708 against current state sources 120, a new authorization decision is evaluated 710, a fresh authorization artifact is generated 712 and represented by artifact record 722, stale initial artifacts are rejected 714, 724, an adapter validates the fresh artifact before transport actions 716, replay or redrive delivery occurs using fresh authorization 718, non-allow current state fails closed 720, delivery may proceed through provider or recipient transport channel 614, and events are recorded in audit log 160.

FIG. 8 illustrates channel-specific delivery adapter validation gates 800 including authorization artifact 606, adapter validation gate 802, allowed channel actions 804, invalid or non-allow artifact handling 806, policy or credential store 170, email adapter 152, inbox or network adapter 154, push notification adapter 156, webhook or application programming interface adapter 158, and audit log 160.

### DETAILED DESCRIPTION

The following description sets forth example embodiments. The described components, records, fields, orders of operation, and implementation mechanisms may be combined, separated, omitted, repeated, or reordered unless a particular claim requires otherwise. References to one embodiment, some embodiments, or an example are not intended to limit the disclosure to a single implementation.

### Terminology

A verified sender record is a stored record, token, data object, database row, graph node, key-value entry, event-stream state, smart-contract state, or other persistent or retrievable state indicating that a sender, account, wallet, public key, organization, tenant, or other entity has satisfied a cryptographic verification process and has been associated with one or more blockchain-recorded assets or identities. A verified sender record may be referred to in supporting systems as a verified sender identity record.

A recipient identifier identifies a delivery endpoint or channel destination associated with a subscriber or recipient. Examples include an email address or hash, platform inbox identifier, application account, push token, webhook endpoint, application programming interface destination, wallet inbox, decentralized messaging address, device identifier, account handle, or other endpoint.

A subscription binding record associates a recipient identifier or subscriber identifier with a verified sender record. The subscription binding record may include opt-in state, opt-in evidence, channel preference, channel type, policy version, binding identifier, status, expiration time, unsubscribe state, revocation state, endpoint status, and audit information. A binding-record data store may store subscription binding records using a relational database, document store, graph store, key-value store, event stream, signed record store, smart contract, memory cache backed by persistent storage, or a combination thereof.

A routing gateway service is a component, service, module, controlled process, gateway boundary, serverless function, queue processor, adapter orchestrator, policy decision service, application gateway, or combination of cooperating components that receives proposed outbound communications and determines whether delivery to each destination recipient is authorized before transport-invocation actions are performed.

A delivery adapter process is a process, service, module, worker, library, sidecar, gateway-adjacent component, serverless function, containerized workload, or other controlled execution unit that interfaces with a delivery channel or provider. A delivery adapter process may handle email, web inbox, push notification, webhook, application programming interface callback, in-platform inbox, network delivery, decentralized messaging, wallet inbox, or another electronic delivery path.

A transport credential includes any credential, secret, account capability, provider session, token, connection context, delegated authority, service identity, scoped credential, or provider account context that is required to perform or commit a recipient-visible outbound action. Examples include an SMTP credential, provider application programming interface key (provider API key), push-provider credential, webhook signing key, inbox-writer credential, OAuth token, client certificate, private key, session ticket, delegated bearer token, service account token, provider account context, or scoped credential for a selected delivery authority.

A cached transport credential includes a previously cached, pre-fetched, session-derived, pre-resolved, provider-account-scoped, connection-pool-based, delegated, or otherwise previously obtained transport credential or transport authority. The system may treat using, unlocking, activating, selecting, forwarding, applying, or committing use of such transport authority as equivalent to retrieving a transport credential when determining whether transport invocation is authorized.

An authorization artifact is an artifact generated, issued, referenced, or caused to exist by the routing gateway service based on an authorization decision. The authorization artifact may include or reference a signed authorization token, gateway-generated authorization decision identifier, signed queue envelope, decision-record pointer, message attribute, service-mesh assertion, policy-decision reference, gateway service identity, selected delivery adapter identifier, provider account identifier, provider endpoint identifier, queue identifier, delivery authority scope, issued-at time, expiration time, nonce, replay-protection value, signature, or policy version.

A current authorization decision is an authorization decision determined using current or recently refreshed authorization state for the relevant communication, recipient, sender, binding, opt-in status, channel type, endpoint state, and policy version. An allow decision is a decision permitting the relevant transport-invocation action. A non-allow decision may include deny, defer, fail-closed, expired, revoked, unsubscribed, endpoint unavailable, reverify required, stale policy, rate limited, abuse blocked, or another state that does not affirmatively permit transport invocation.

### System Overview

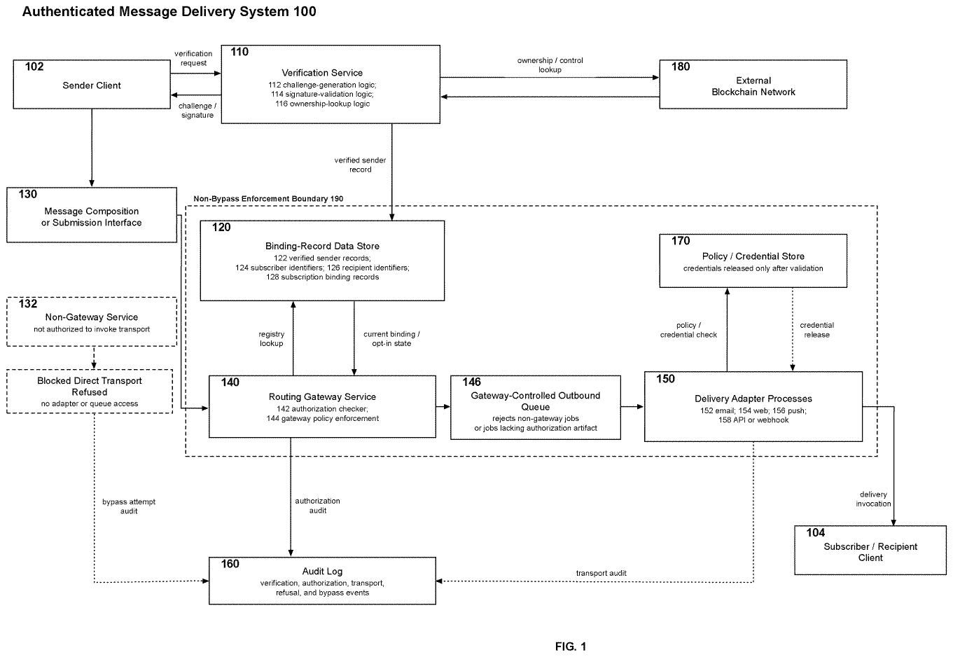

FIG. 1 illustrates an example authenticated message delivery system 100. A sender client 102 may request verification for a blockchain-linked asset or identity. A verification service 110 may include challenge-generation logic, signature-validation logic, and ownership-lookup logic configured to generate a cryptographic challenge, validate a signature, perform an ownership or control lookup against an external blockchain network 180 or ownership registry, and create or update a verified sender record. A subscription registry or binding-record data store 120 may store subscription binding records linking verified sender identifiers to recipient identifiers and opt-in state. A message composition or submission interface 130 and non-gateway service 132 may submit proposed communications, but a routing gateway service 140 may receive proposed outbound communications and act as the controlled outbound boundary. A gateway-controlled outbound queue 146 may accept only gateway-authorized jobs. Delivery adapter processes 150 may interface with delivery channels, and policy or credential store 170 may enforce access control. An audit log 160 may record verification, binding, authorization, transport, refusal, retry, redrive, and bypass-attempt events. A non-bypass enforcement boundary 190 may define components and paths that prevent direct transport invocation outside the controlled gateway path.

Application components that compose content do not directly invoke delivery transports. Instead, a message-composition service, campaign service, content-management service, administrator console, sender application programming interface service (sender API service), or other non-gateway service submits a proposed communication to the routing gateway service or to an inbound queue controlled by the routing gateway service. The routing gateway service determines recipient-specific authorization and provides authorization artifacts only for allowed recipients. A delivery adapter process validates the authorization artifact before performing the first action that would place the communication on an outbound delivery path.

### Verification Service And Ownership Lookup

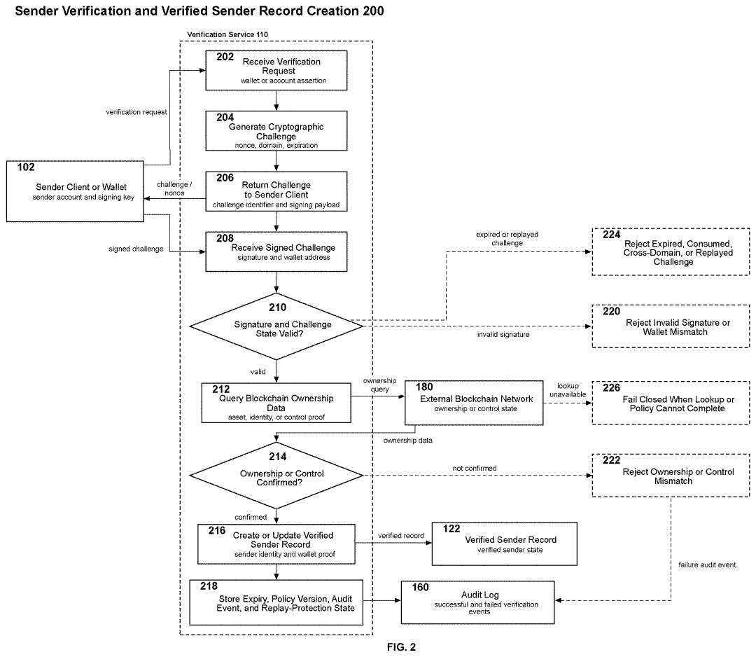

FIG. 2 illustrates an example sender verification flow 200. A verification service 110 may receive a verification request 202 from a sender client or wallet 102 to verify a sender for a wallet address, public key, smart contract, token, non-fungible token, domain, decentralized identifier, subscription service, brand, channel, or other blockchain-linked identity. The request may include a sender account identifier, wallet address, chain identifier, asset address, token identifier, requested verification scope, requested expiration period, client device identifier, session identifier, risk signal, or requested signature scheme.

The verification service may generate a challenge 204 and create a VerificationChallenge record. The challenge may include a challenge identifier, nonce, random value, counter value, session identifier, wallet address, public key, chain identifier, asset identifier, intended action, issued-at time, expiration time, origin domain, domain separator, replay-protection value, and a hash or copy of the signing payload. The verification service may return the signing payload 206 to the sender client for signature using a wallet, private key, custody system, hardware key, software key, delegated signer, account-abstraction wallet, multi-signature wallet, or other cryptographic signing mechanism.

After receiving a signed challenge 208, the verification service may retrieve the stored VerificationChallenge record, confirm that the challenge is unexpired and unused, reconstruct or retrieve the signing payload, validate the signature 210 by confirming that the signature corresponds to the expected wallet address or public key, validate the signature scheme, chain identifier, origin domain, intended action, and replay-protection value, and reject stale, modified, replayed, cross-domain, cross-chain, cross-context, or mismatched payloads. A challenge may be marked consumed after successful signature validation. Expired, consumed, or malformed challenges may be rejected at step 224, and invalid signatures or wallet mismatches may be rejected at step 220.

The verification service may then determine ownership or control of a blockchain-recorded asset or identity. The verification service may query blockchain ownership or control 212 using a blockchain node, smart contract, token contract, non-fungible token contract, registry contract, event log, indexer, subgraph, delegated-authority registry, multi-signature wallet contract, domain registry, custody assertion, ownership service, cached ownership snapshot, or external blockchain network 180. The query may call an ownerOf, balanceOf, getApproved, isApprovedForAll, admin, owner, controller, resolver, registry, deployment, delegation, or equivalent function. The verification service may compare a current owner, operator, administrator, controller, delegate, or authorized signer address to the signature-validated wallet address or a recognized delegated-authority record. Ownership or control failures may be rejected at step 222, and ownership lookup or policy failures may be rejected at step 226.

When the signature validation and ownership or control lookup satisfy the applicable verification policy, the verification service may determine that ownership or control is verified 214 and create or update a verified sender record 216. The verified sender record 122 may include a verified sender identifier, sender account identifier, wallet address, public key, chain identifier, asset type, asset address, token identifier, verification challenge identifier, ownership proof identifier, verification method, policy version, verification status, verified-at time, expiration time, revocation state, re-verification state, and scope. The scope may define the subscription service, brand, contract, collection, asset, channel, tenant, or communication context for which the record is valid. The system may store expiry, policy version, and audit information 218 in or with the verified sender record 122 and audit log 160.

The verified sender record may remain active for a fixed duration, until ownership changes, until a revocation event, until an account-compromise signal, until a policy update, until a channel-scope change, or until a re-verification rule requires a new challenge. The verification service may monitor ownership changes by blockchain polling, event subscriptions, indexer callbacks, registry lookups, or delivery-time checks. If ownership changes or verification expires, the verification service may mark the verified sender record inactive, transferred, expired, revoked, suspended, or reverify-required.

### Subscription Binding Records

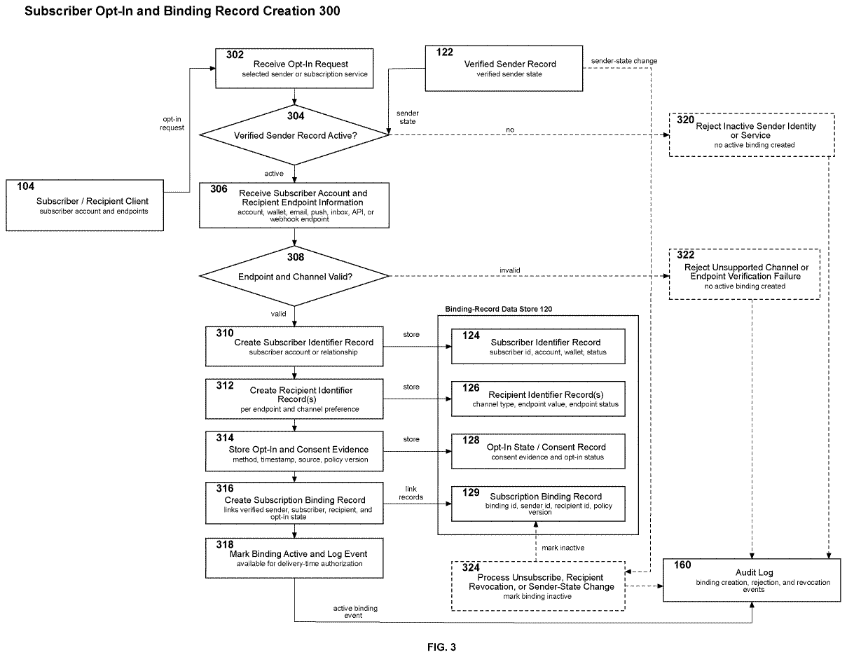

FIG. 3 illustrates an example subscriber opt-in and binding-record flow 300. A subscriber or recipient client 104 may submit an opt-in request 302 for communications associated with a verified sender record 122, subscription service, asset, brand, collection, channel, tenant, or communication scope. The system may determine whether the verified sender record is active 304, receive subscriber account and recipient endpoint information 306, and determine whether the endpoint and channel are valid 308. The binding-record data store 120 may store subscriber identifier records 124, recipient identifier records 126, opt-in state or consent records 128, channel preferences, subscription status, endpoint status, revocation state, policy version, audit data, and subscription binding records 129.

The system may create a subscriber identifier record 310, create one or more recipient identifier records 312, store opt-in and consent evidence 314, create a subscription binding record 316, and mark the binding active and log an event 318. A subscription binding record may reference a verified sender identifier, recipient identifier, subscriber identifier, opt-in record identifier, channel type, subscription service identifier, asset address, token identifier, status, created-at time, expiration time, revoked-at time, unsubscribe time, source, consent evidence, and policy version. A binding may be active only when the verified sender record is active for the relevant scope, the subscriber or recipient has opted in, the recipient endpoint is active, the channel is permitted, no unsubscribe state is present, and no ownership-transfer, revocation, or policy state has invalidated the binding.

The binding-record data store may support exact matching between a verified sender identifier and a recipient identifier. In some embodiments, a subscriber-level binding authorizes multiple recipient identifiers. In other embodiments, each recipient identifier must have an active binding record for the relevant verified sender identifier and channel type. The routing gateway service may reject ambiguous, conflicting, expired, revoked, inactive, or mismatched binding results. In the illustrated example, an inactive sender identity or service may be rejected at step 320, an unsupported channel or endpoint verification failure may be rejected at step 322, and an unsubscribe, recipient revocation, or sender-state change may be processed at step 324 to mark a binding inactive and record a corresponding audit event in audit log 160.

### Routing Gateway Service

The routing gateway service receives proposed outbound communications and converts current recipient authorization state into controlled transport authority. When the routing gateway service receives a proposed outbound communication, it may authenticate the caller, determine the verified sender record associated with the proposed communication, retrieve or validate current verification state, create or update a CommunicationRecord, normalize destination data into RecipientIdentifier records, determine requested channels, apply policy labels, rate limits, abuse checks, content checks, tenant boundaries, and channel restrictions, and create an audit event indicating that the proposed communication entered the controlled outbound path.

The routing gateway service may reject intake before authorization if the caller is not authorized to submit communications for the verified sender record, the verified sender record is absent or inactive, required metadata is missing, the destination list cannot be normalized, the requested channel is unsupported, or policy denies intake.

For each recipient identifier, the routing gateway service queries the binding-record data store for an active subscription binding record linking the recipient identifier or subscriber identifier to the verified sender record and to the relevant subscription service, brand, asset, collection, channel, tenant, or communication scope. The query may retrieve opt-in evidence, channel preference, unsubscribe status, endpoint status, revocation state, policy version, and recent ownership or verification state.

The routing gateway service creates an AuthorizationDecision for each recipient. A decision may be allow only when the verified sender record is active, the CommunicationRecord references that verified sender record, the recipient identifier is active, an active subscription binding record links the recipient or subscriber to the verified sender record, an active opt-in record supports the binding, no unsubscribe or revocation state invalidates the binding, the requested channel is permitted, the gateway policy permits the selected delivery adapter process, and the delivery-time authorization check completes successfully. If any condition is not satisfied, the routing gateway service records a non-allow decision and does not provide transport authority for that recipient.

Batch messages may include multiple recipients. The routing gateway service may evaluate each recipient separately and create separate authorization decisions. Authorized recipients may be delivered while unauthorized recipients are blocked. A policy may instead block an entire batch if a required registry lookup, verification-state lookup, ownership lookup, policy lookup, credential validation, adapter validation, or channel check cannot be completed.

### Authorization Artifacts

Only when a current authorization decision is an allow decision does the routing gateway service generate, issue, reference, or cause to be available an authorization artifact for a recipient. The authorization artifact may comprise a signed authorization token, a gateway-generated authorization decision identifier that uniquely identifies an authorization decision record stored by the routing gateway service, a signed queue envelope, a decision-record pointer, a policy-decision reference, a service-mesh assertion, a message attribute, or another artifact that a delivery adapter process can validate or resolve.

The authorization artifact may include or reference a signature, replay-protection value, gateway service identity, selected delivery adapter identifier, provider account identifier, provider endpoint identifier, provider tenant identifier, queue identifier, delivery authority scope, channel-specific transport authority, decision timestamp, issued-at time, expiration time, nonce, policy version, and an authorization decision record stored by the routing gateway service.

The authorization artifact may be bound to the communication identifier, recipient identifier, channel type, verified sender identifier, binding identifier, policy version, issued-at time, expiration time, nonce, selected delivery adapter identifier, provider account identifier, provider endpoint identifier, queue identifier, delivery authority scope, or other scope selected by the routing gateway service. Binding the artifact to these fields prevents a caller from using an allow decision for one communication, recipient, channel, sender, adapter, provider account, provider endpoint, queue, or delivery authority as substitute authority for another transport path.

In some embodiments, the authorization artifact is a signed token that includes the bound fields. In other embodiments, the authorization artifact is a decision identifier that points to a stored AuthorizationDecision record containing the bound fields. In other embodiments, the authorization artifact includes both a signed token and a decision identifier. A delivery adapter process may validate the signed token locally, resolve the decision identifier against a decision store, call the routing gateway service for validation, or combine these validation methods.

The delivery adapter process may reject the authorization artifact when the artifact is absent, expired, replayed, associated with a non-allow decision, associated with a stale policy version, or mismatched to any of the communication identifier, recipient identifier, channel type, verified sender identifier, selected delivery adapter identifier, provider account identifier, provider endpoint identifier, queue identifier, or delivery authority scope to which the artifact is bound.

### Delivery Adapter Validation Before Transport Invocation

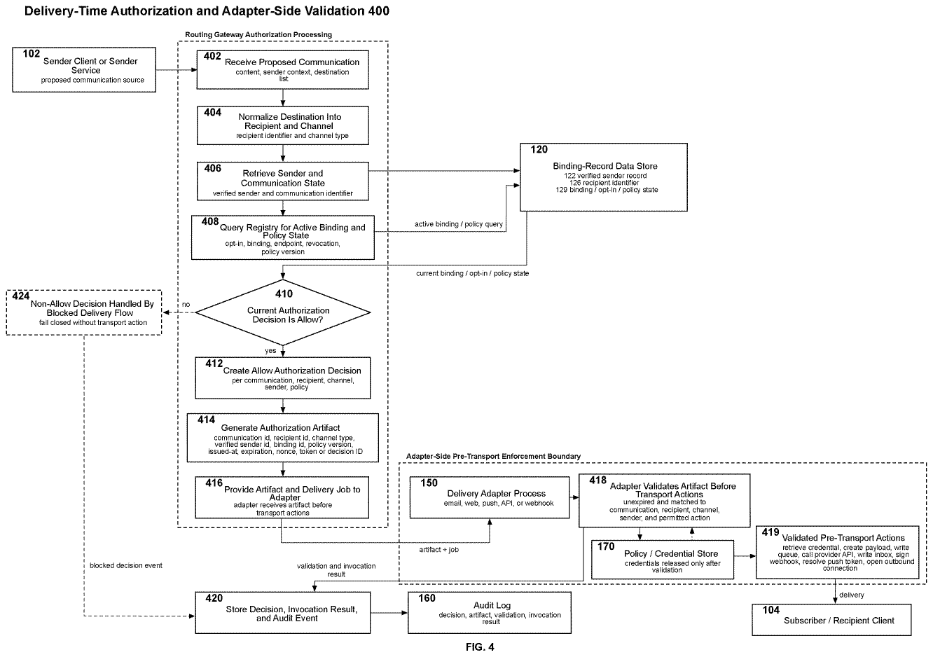

FIG. 4 illustrates an example delivery-time authorization and adapter-side validation flow 400. A sender client or sender service 102 may submit a proposed communication 402. Gateway authorization processing may normalize the destination into a recipient and channel 404, retrieve sender and communication state 406, query a registry for active binding and policy state 408 using the binding-record data store 120, and determine whether a current authorization decision is an allow decision 410. When an allow decision is present, the system may create an allow authorization decision 412, generate an authorization artifact 414, and provide the artifact and delivery job to an adapter 416. A delivery adapter process 150 receives an adapter request or authorized delivery instruction from the routing gateway service. Before performing a transport-invocation action, the delivery adapter process validates the authorization artifact 418 and confirms that the artifact matches the communication identifier, recipient identifier, channel type, verified sender identifier, binding identifier, policy version, selected delivery adapter identifier, provider account identifier, provider endpoint identifier, queue identifier, or delivery authority scope required for the requested transport action.

Validated pre-transport actions 419 may include retrieving a transport credential, using a cached transport credential, unlocking or activating a credential, selecting a provider account, creating or finalizing a channel payload, writing an outbound queue entry, calling a provider application programming interface (provider API), writing to an inbox store, signing a webhook request, resolving a push token or endpoint, opening an outbound network connection, handing a payload to a transport worker, or committing an outbound delivery record that causes a provider or worker to transmit the communication to a subscriber or recipient client 104. Decision, invocation result, and audit data may be stored at step 420 in audit log 160. A non-allow decision may be handled by a blocked flow 424 that fails closed without transport invocation.

The first transport-invocation action may differ by channel or deployment. In an email embodiment, the first action may be retrieving or using an SMTP credential, creating or finalizing an email payload, writing an email job to an outbound queue, or calling an email provider application programming interface. In a webhook embodiment, the first action may be resolving an endpoint, signing a webhook request, or opening an outbound network connection. In an inbox embodiment, the first action may be writing a recipient-visible row or notification object. In a push embodiment, the first action may be resolving a push token or creating a device-targeted payload. The gateway or adapter may validate authorization before whichever of these actions would first put the communication into a transport path.

In some embodiments, a delivery adapter process implements a state machine that receives an adapter request from the routing gateway service, verifies the gateway service identity, validates the authorization artifact, confirms that the artifact matches the relevant communication, recipient, channel, verified sender, and selected transport scope, rejects the request if the decision is not allow or is expired, retrieves or uses a transport credential only after validation, creates or finalizes the channel-specific payload, invokes a provider API, queue, inbox writer, webhook endpoint, push service, or other transport, and records a provider response, delivery status, failure reason, TransportInvocationRecord, or audit event.

### Transport Credential Scope And Cached Authority

The system may treat a broad range of transport authority as a transport credential. Transport authority may include a stored credential, secret, provider account context, session, token, connection, delegated authority, or service identity required to perform or commit a recipient-visible outbound action. The system may treat using, unlocking, activating, selecting, forwarding, applying, or committing such authority as a controlled transport action.

In some embodiments, a delivery adapter process may have previously cached or pre-resolved a transport credential, provider session, network connection, provider account context, connection pool entry, session ticket, delegated bearer token, service account token, client certificate, private key, or other transport authority. The adapter is nevertheless prevented from using the cached or pre-resolved authority for a recipient-visible outbound action unless a current authorization artifact validates for the communication identifier, recipient identifier, channel type, verified sender identifier, and applicable policy version. Thus, authorization may be enforced at credential-retrieval time, credential-use time, provider-account selection time, connection-use time, request-signing time, queue-write time, endpoint-resolution time, or outbound-action-commit time.

Where a credential was previously cached by an adapter, refusal may include preventing the adapter from using the cached credential, requiring the adapter to discard, lock, rotate, ignore, or segregate the cached credential, or requiring the adapter to select a different provider account or queue unless a current allow decision and valid authorization artifact are present.

### Non-Bypass Enforcement

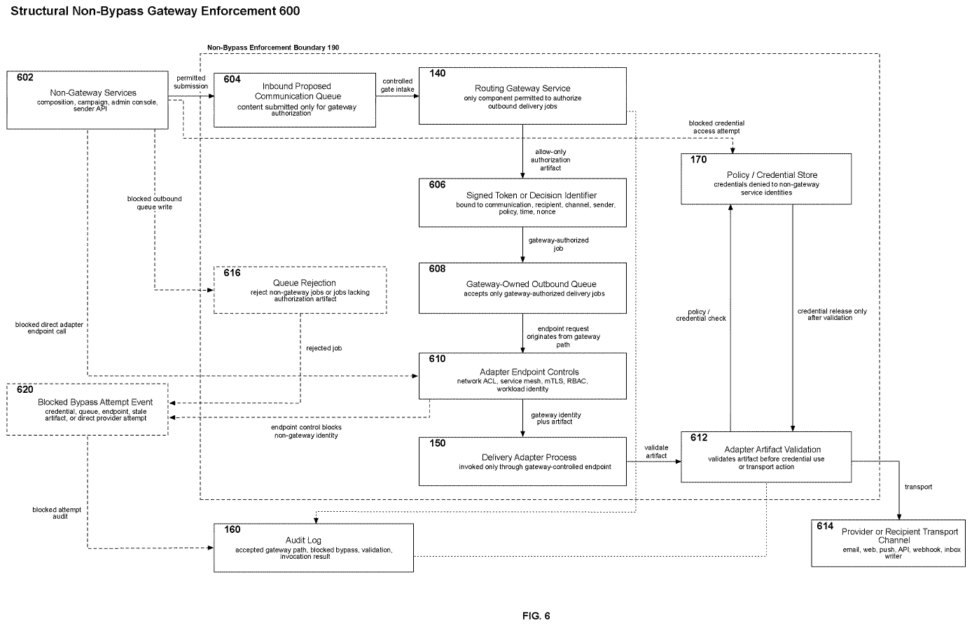

FIG. 6 illustrates examples of structural non-bypass enforcement 600. Non-gateway services 602 may include a message-composition service, campaign service, content-management service, administrator console, sender application programming interface service, or other component that can create proposed message content but is not permitted to cause recipient-visible outbound transport actions without the routing gateway service 140.

A non-bypass control may prevent a non-gateway service identity from retrieving or using a transport credential by credential-store access policy or credential-use policy. A policy or credential store 170 may deny non-gateway service identities access to SMTP credentials, provider application programming interface keys (provider API keys), push-provider credentials, webhook signing keys, inbox-writer credentials, OAuth tokens, client certificates, private keys, session tickets, delegated bearer tokens, service account tokens, provider account contexts, or other capabilities required to perform or commit recipient-visible outbound actions. In the illustrated example, a blocked credential access attempt may be directed to the policy or credential store 170 and denied.

A routing gateway service 140 may own or exclusively control an outbound delivery queue 608. Non-gateway components may write only to an inbound proposed-communication queue 604 or content-submission interface. The outbound delivery queue 608 may reject a delivery job 616 that is submitted by a non-gateway service identity or that lacks an authorization artifact 606. Queue ownership may be enforced by access-control lists, queue policies, service-account restrictions, signed job envelopes, message attributes, authorization-decision references, hidden queue names, queue writer policies, or workload identity rules.

An adapter endpoint access control 610 may prevent a non-gateway service from reaching an endpoint of a delivery adapter process 150 unless a request originates from the routing gateway service 140 and carries a valid authorization artifact 606. Adapter artifact validation 612 may validate the artifact before credential use or transport action. The access control may include a network access control, service-mesh policy, mutual-TLS service-identity rule, role-based access-control rule, private subnet restriction, firewall rule, egress policy, workload identity rule, container policy, provider-account segmentation rule, or application programming interface gateway rule. After validation, a provider or recipient transport channel 614 may be invoked.

These controls make the authorization check part of the technical delivery path rather than merely a rule that application code is expected to follow. In a bypass attempt, such as a non-gateway service calling a delivery adapter process, writing an unauthorized outbound queue job, presenting a stale or mismatched authorization artifact, reaching a provider endpoint directly, or using a cached credential outside the authorized scope, the system may create a blocked bypass attempt event 620, record an audit event in audit log 160, notify an administrator, rotate credentials, suspend a sender account, increase a risk score, or quarantine related jobs.

### Fail-Closed Refusal

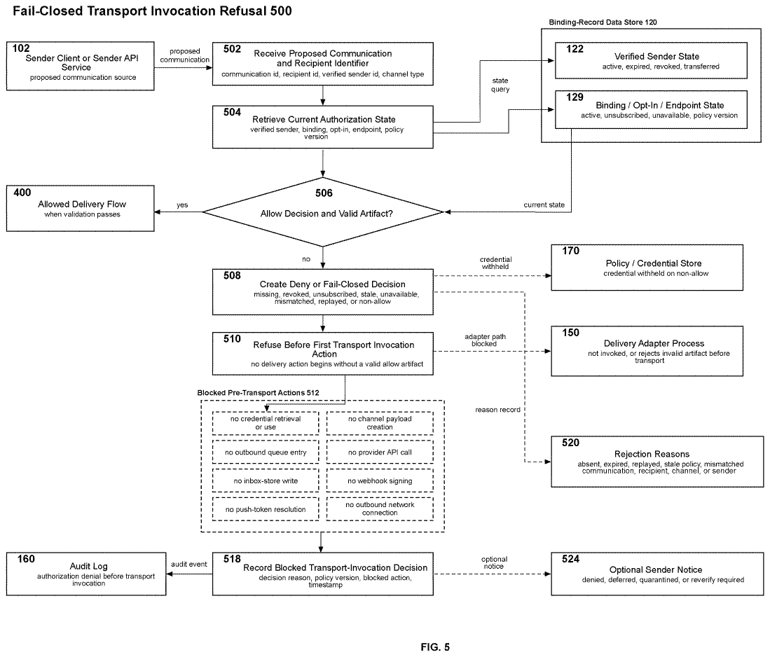

FIG. 5 illustrates fail-closed refusal 500. A sender client or sender API service 102 may submit a proposed communication to be received with a recipient identifier 502. The routing gateway service may retrieve current authorization state 504, including verified sender state 122 and binding, opt-in, or endpoint state 129 from a binding-record data store 120. The routing gateway service and delivery adapter process 150 may operate under a fail-closed rule. Under the fail-closed rule, the system does not invoke a transport unless it affirmatively determines that delivery is authorized and the delivery adapter process validates a current authorization artifact at decision point 506. If validation passes, processing may proceed to allowed delivery flow 400.

Fail-closed conditions may include no active verified sender record, expired or revoked verified sender record, transferred ownership or unavailable ownership state, no active subscription binding record, absent or revoked opt-in evidence, unsubscribed recipient, inactive or unavailable recipient endpoint, failed registry lookup, conflicting registry results, stale verification state, unavailable policy store, unavailable credential validation, adapter inability to validate the authorization artifact, unconfirmed ownership or delegation state, missing gateway token, stale policy version, replayed artifact, mismatched artifact field, rate-limit block, abuse block, tenant-policy block, or channel-policy block.

When a fail-closed condition occurs, the system may deny delivery, defer delivery, quarantine the communication, request re-verification, notify the sender, escalate the event for review, create a deny or fail-closed decision 508, create a blocked TransportInvocationRecord, record rejection reasons 520, optionally send a sender notice 524, or record an audit event identifying the refusal reason. The system may refuse before the first transport invocation action 510 and may prevent blocked pre-transport actions 512. The system refrains from retrieving a transport credential, using a cached transport credential, creating a channel payload, writing an outbound queue entry, calling a provider application programming interface (provider API), writing to an inbox store, signing a webhook request, resolving a push token, or opening an outbound network connection while the fail-closed condition remains unresolved. A blocked transport-invocation decision may be recorded at step 518 and stored in audit log 160, and a policy or credential store 170 may withhold credentials on a non-allow decision.

The system may distinguish authorization denial from provider failure. A provider failure occurs after an allow decision and transport invocation, for example when an email provider returns a temporary error. An authorization denial occurs before transport invocation, for example when no active binding record exists or an authorization artifact fails validation. This distinction may be stored in AuthorizationDecision, TransportInvocationRecord, AuditEvent, retry queue, dead-letter queue, or reporting records.

A provider failure, transport timeout, partial delivery, or other post-allow invocation failure does not authorize stale replay of the original transport authority. When such a failure causes a retry queue item or dead-letter queue item to be replayed or redriven, the system still requires the routing gateway service to generate a new authorization decision and, when the new authorization decision is an allow decision, a fresh authorization artifact before the delivery adapter process performs any replay-time or redrive-time transport-invocation action.

### Delivery-Time Recheck

A communication may be composed, scheduled, batched, or queued before actual transport invocation. The routing gateway service may perform an authorization recheck after the proposed communication is queued and before the delivery adapter process performs the first transport-invocation action. The recheck may confirm current verified-sender state, current binding-record state, current opt-in state, current endpoint state, current channel policy, current ownership or control state, current policy version, and current adapter or credential policy.

If the authorization recheck changes the current authorization decision to a non-allow decision, the system may deny, defer, or fail closed for the affected recipient. Conditions that may change a decision include a verified sender record expiring or being revoked, ownership or control of the blockchain-recorded asset or identity transferring or becoming unavailable, the subscription binding record becoming inactive, the opt-in state changing to an unsubscribe state, a recipient endpoint becoming unavailable, a channel policy changing, a provider endpoint becoming unavailable, or a policy version becoming stale.

### Retry And Dead-Letter Fresh Authorization

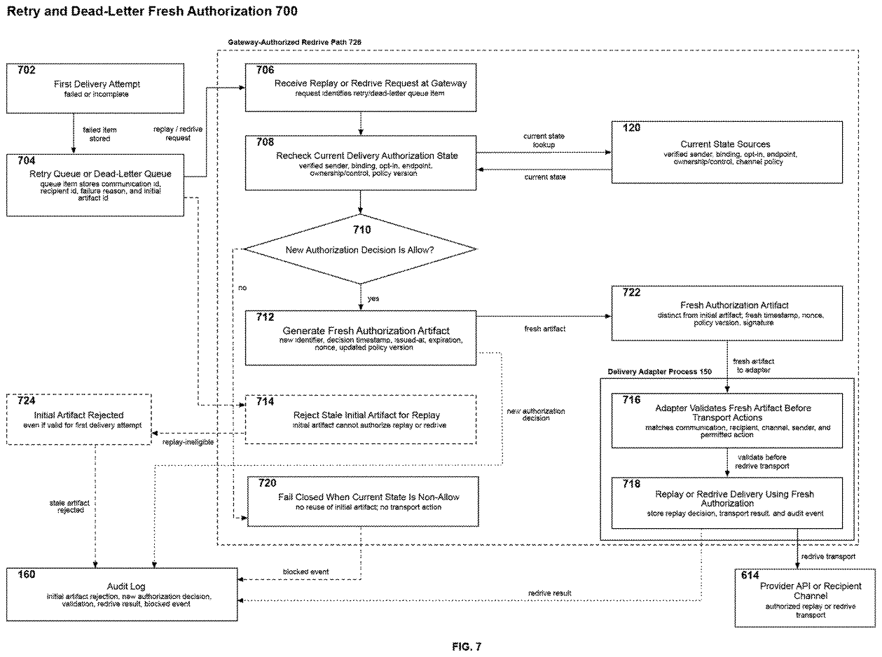

FIG. 7 illustrates replay or redrive of a failed or incomplete outbound communication 700. After a first delivery attempt 702 for a communication identifier and recipient identifier fails or does not complete, the system may store a queue item in a retry queue or dead-letter queue 704. The queue item may be associated with the communication identifier, recipient identifier, channel type, initial authorization artifact, initial authorization decision identifier, failure reason, retry count, policy version, provider response, timestamp, and TransportInvocationRecord. A gateway-authorized redrive path 726 may define the controlled path through which replay or redrive requests are processed.

The initial authorization artifact may remain stored for audit, diagnosis, or failure-classification use. However, storage of the initial artifact does not make the artifact valid for replay. The routing gateway service may mark the initial authorization artifact as replay-ineligible after the first delivery attempt fails or remains incomplete. Replay-ineligible status may be stored in the AuthorizationDecision, TransportInvocationRecord, retry-queue item, dead-letter record, audit record, or a related replay-control record. The initial authorization artifact may remain unexpired according to its original expiration time while still being unusable for the replay or redrive request.

When a replay request or redrive request is received for the queue item at gateway step 706, the routing gateway service may generate a new authorization decision by rechecking current delivery authorization state 708, including current verified-sender state, current binding-record state, current opt-in state, current endpoint state, and current channel policy from current state sources 120. Only when the new authorization decision is an allow decision at decision point 710 does the routing gateway service generate a fresh authorization artifact 712. The fresh authorization artifact may be represented by a fresh authorization artifact record 722 and may differ from the initial authorization artifact by at least one of an artifact identifier, decision timestamp, issued-at time, expiration time, nonce, replay-protection value, policy version, binding-record state, signature, selected delivery adapter identifier, provider account identifier, provider endpoint identifier, queue identifier, or delivery authority scope.

A delivery adapter process 150 may reject reuse of the initial authorization artifact at step 714 or step 724 for the replay request or redrive request even when the initial authorization artifact was valid or unexpired for the first delivery attempt. The delivery adapter process validates the fresh authorization artifact before transport actions 716, including before retrieving a transport credential, using a cached transport credential, creating a channel payload, writing an outbound queue entry, calling a provider application programming interface, writing to an inbox store, signing a webhook request, resolving a push token, opening an outbound network connection, or otherwise redriving the communication. Replay or redrive delivery may then use the fresh authorization at step 718 and proceed through provider or recipient transport channel 614. If current state is non-allow, the system may fail closed at step 720 without reuse of the initial artifact and without transport action. Initial artifact rejection, new authorization decision, validation, redrive result, and blocked events may be recorded in audit log 160.

A retry queue or dead-letter queue may contain queue items for multiple recipient identifiers. The routing gateway service may generate a separate new authorization decision and a separate fresh authorization artifact for each recipient identifier before replaying or redriving a corresponding failed delivery item. A gateway-authorized redrive path may prevent a non-gateway service identity from reading the queue item, writing the queue item to an outbound delivery queue, retrieving or using a transport credential, or reaching an endpoint of a delivery adapter process unless the routing gateway service has generated the fresh authorization artifact.

### Channel-Specific Adapter Gates

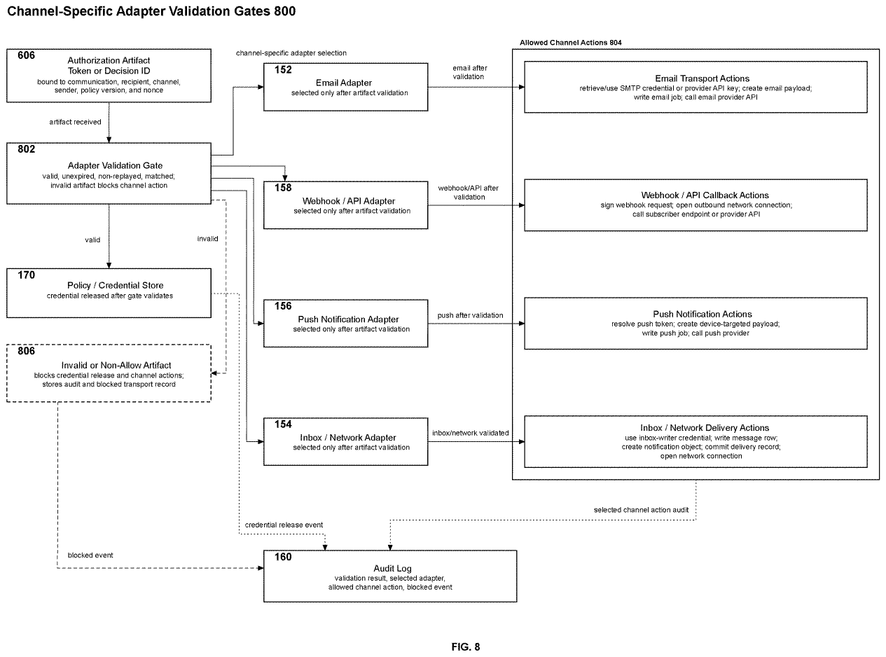

FIG. 8 illustrates channel-specific delivery adapter gates 800. An authorization artifact 606 may be received by an adapter validation gate 802. When the artifact validates, the system may select a channel-specific adapter, such as an email adapter 152, a webhook or application programming interface adapter 158, a push notification adapter 156, or an inbox or network adapter 154. Allowed channel actions 804 are performed only after validation. An invalid or non-allow artifact 806 prevents the channel action and may cause a blocked event, credential-release event, or selected-channel action audit to be recorded in an audit log 160.

For email delivery, the recipient identifier may include an email address or hash of an email address, and refusal to perform a transport action may include not retrieving or using an SMTP credential or provider application programming interface key (provider API key), not creating an email payload, not writing an email delivery job, and not calling an email provider application programming interface (email provider API) unless the authorization artifact validates and the current authorization decision is the allow decision.

For webhook or application programming interface callback delivery, a delivery adapter process may sign a request and open an outbound network connection to a subscriber endpoint. Refusal to perform a transport action may include not signing the webhook request, not opening the outbound network connection, and not calling the subscriber endpoint, subscriber API endpoint, provider endpoint, or provider API unless the authorization artifact validates and the current authorization decision is the allow decision.

For push-notification delivery, the delivery adapter process may map a recipient identifier to a push token. Refusal to perform a transport action may include not resolving the push token, not creating a device-targeted payload, not writing a push-delivery job, and not calling a push-notification provider unless the authorization artifact validates and the current authorization decision is the allow decision.

For in-platform inbox or network delivery, the delivery adapter process may write a recipient-visible message row, notification object, or outbound delivery record. Refusal to perform a transport action may include not using an inbox-writer credential, not writing a message row to the inbox store, not creating a recipient-visible notification object, not committing an outbound delivery record, and not opening an outbound network connection unless the authorization artifact validates and the current authorization decision is the allow decision.

For wallet or decentralized messaging delivery, refusal to perform a transport action may include not resolving a wallet inbox, not encrypting a payload for a wallet endpoint, not writing to a decentralized messaging relay, not submitting a message transaction, or not opening a network connection unless the authorization artifact validates and the current authorization decision is the allow decision.

### Data Structures

The system may store VerificationChallenge, OwnershipProof, VerifiedSenderRecord, SubscriberIdentifier, RecipientIdentifier, SubscriptionBindingRecord, OptInRecord, CommunicationRecord, AuthorizationDecision, TransportInvocationRecord, GatewayPolicyRecord, ReplayControlRecord, and AuditEvent records. These structures may be implemented as database tables, documents, graph nodes, key-value records, event records, smart-contract records, signed tokens, in-memory objects, queue messages, or combinations thereof.

A VerificationChallenge may include a challenge identifier, nonce, challenge payload, sender account hint, wallet address, public key, chain identifier, asset address, token identifier, signature scheme, created-at time, issued-at time, expiration time, used-at time, status, and replay-protection value.

An OwnershipProof may include an ownership proof identifier, wallet address, chain identifier, asset type, asset address, token identifier, ownership source, owner lookup method, owner address, matched wallet address, block number, checked-at time, proof status, and proof payload.

A VerifiedSenderRecord may include a verified sender identifier, creator account identifier, wallet address, public key, chain identifier, asset type, asset address, token identifier, verification challenge identifier, ownership proof identifier, verification method, verification policy version, verification status, verified-at time, expiration time, revoked-at time, revocation reason, re-verification status, scope, and last reverified-at time.

A SubscriberIdentifier may include a subscriber identifier, user account identifier, subscriber wallet address, account handle, created-at time, status, authentication method, and metadata. A RecipientIdentifier may include a recipient identifier, subscriber identifier, channel type, endpoint value, endpoint hash, verified endpoint status, created-at time, updated-at time, revoked-at time, and channel preference.

A SubscriptionBindingRecord may include a binding identifier, verified sender identifier, subscriber identifier, recipient identifier, subscription service identifier, asset address, token identifier, opt-in record identifier, status, created-at time, expiration time, revoked-at time, unsubscribe time, source, consent evidence, and policy version.

An OptInRecord may include an opt-in record identifier, subscriber identifier, recipient identifier, verified sender identifier, subscription service identifier, opt-in method, opt-in timestamp, consent text version, source address, proof, and status.

A CommunicationRecord may include a communication identifier, verified sender identifier, creator account identifier, content reference, subject, body hash, submitted-at time, destination recipient identifiers, channel preferences, status, and scheduled delivery time.

An AuthorizationDecision may include an authorization decision identifier, communication identifier, verified sender identifier, recipient identifier, subscriber identifier, binding identifier, decision, decision reason, checked-at time, policy version, registry snapshot reference, fail-closed indicator, audit event identifier, authorization artifact identifier, gateway service identity, selected delivery adapter identifier, provider account identifier, provider endpoint identifier, provider tenant identifier, queue identifier, delivery authority scope, issued-at time, expiration time, nonce, replay-protection value, signature, artifact status, and replay eligibility.

A TransportInvocationRecord may include a transport invocation identifier, authorization decision identifier, communication identifier, recipient identifier, channel type, transport adapter identifier, credential reference, invocation status, invoked-at time, provider response code, retry count, dead-letter queue identifier, blocked reason, first transport action, authorization artifact validation time, credential use status, replay-of invocation identifier, fresh authorization required indicator, cached credential used indicator, cached credential identifier, provider account identifier, provider endpoint identifier, queue identifier, and initial artifact replay eligibility.

A GatewayPolicyRecord may include a policy identifier, allowed caller service identifiers, transport credential references, authorized queue identifiers, adapter endpoint policies, network policy references, required authorization token type, fail-closed rules, policy version, effective-at time, credential-use policies, queue-writer policies, egress policy references, service-mesh policy references, mutual-TLS identity rules, workload identity rules, provider account policies, cached credential policies, provider scope binding rules, and replay eligibility rules.

A ReplayControlRecord may include a replay control identifier, communication identifier, recipient identifier, initial authorization artifact identifier, initial authorization decision identifier, retry queue identifier, dead-letter queue identifier, replay request identifier, redrive request identifier, replay eligibility state, fresh authorization artifact identifier, new authorization decision identifier, policy version, issued-at time, expiration time, nonce, and replay decision reason.

An AuditEvent may include an audit event identifier, event type, actor type, actor identifier, record type, record identifier, timestamp, previous state hash, new state hash, decision reason, signature, and tamper-evidence value.

### Example Authorization Rule

A routing gateway service may authorize delivery for a recipient only if the verified sender record is active, the CommunicationRecord references that verified sender record, the RecipientIdentifier is active, an active SubscriptionBindingRecord links the RecipientIdentifier or SubscriberIdentifier to the verified sender record, the OptInRecord is active and not revoked, no unsubscribe or ownership-transfer rule invalidates the binding, the GatewayPolicyRecord permits the requested channel and selected adapter, and the authorization check completes successfully at or near transport invocation time. If any condition fails, the routing gateway service creates a non-allow decision and refuses transport invocation for that recipient.

### Implementation Variations

The routing gateway service may be a single service or a distributed boundary made from multiple cooperating services. For example, an application programming interface gateway may receive proposed communications, a policy decision service may evaluate current recipient authorization, a queue service may accept only gateway-signed jobs, and an adapter orchestrator may provide an authorization artifact to a selected delivery adapter process. These components collectively form the routing gateway service when they enforce the mandatory outbound path.

The verification service, binding-record data store, routing gateway service, credential store, policy store, audit log, and delivery adapter process may be implemented on one server, across multiple servers, in a cloud service, in a private network, in containerized workloads, through serverless functions, in a trusted execution environment, using local modules, or using combinations of hardware and software. A system may include one or more processors and one or more non-transitory memories storing instructions that cause the processors to perform the described operations, and the described operations may also be embodied in a non-transitory computer-readable medium storing executable instructions. Records may be stored in persistent storage or in caches backed by persistent storage.

The described techniques may be used with synchronous delivery, asynchronous delivery, scheduled delivery, batch delivery, queue-based delivery, provider-worker delivery, in-platform messaging, decentralized messaging, or hybrid delivery. The authorization artifact may be validated locally by an adapter, validated by calling the routing gateway service, validated by resolving a decision identifier against a decision store, validated through a service-mesh policy, or validated using a combination of those mechanisms.

The invention claimed is:

1. A system comprising:
one or more processors; and
one or more non-transitory memories storing instructions that, when executed by the one or more processors, cause the system to:
generate, by a verification service comprising challenge-generation logic, signature-validation logic, and ownership-lookup logic, a cryptographic challenge for a wallet address or public key, receive a signature over the cryptographic challenge, validate the signature, determine ownership or control of a blockchain-recorded asset or identity, and create or update a verified sender record for the wallet address or public key when the signature validation and ownership or control determination satisfy a verification policy;
store, in a binding-record data store, a subscription binding record keyed by at least a verified sender identifier and a recipient identifier, the subscription binding record associating the recipient identifier with the verified sender record and an opt-in state;
receive, at a routing gateway service, a proposed outbound communication associated with the verified sender record and the recipient identifier;
determine, by the routing gateway service, a current authorization decision for the recipient identifier based on at least the verified sender record, the subscription binding record, the opt-in state, a channel type, and a policy version;
only when the current authorization decision is an allow decision, generate an authorization artifact comprising either a signed authorization token or a gateway-generated authorization decision identifier that uniquely identifies an authorization decision record stored by the routing gateway service, the authorization artifact being bound to at least
a communication identifier,
the recipient identifier,
the channel type,
the verified sender identifier,
a binding identifier,
the policy version,
an issued-at time,
an expiration time,
and a nonce;
provide the authorization artifact to a delivery adapter process;
require the delivery adapter process, before
retrieving a transport credential,
using a cached transport credential,
creating a channel payload,
writing an outbound queue entry,
calling a provider API,
writing to an inbox store,
signing a webhook request,
resolving a push token,
or opening an outbound network connection,
to validate the authorization artifact and confirm that the authorization artifact matches
the communication identifier,
the recipient identifier,
the channel type,
and the verified sender identifier and is unexpired;
refrain from
retrieving the transport credential,
using the cached transport credential,
creating the channel payload,
writing the outbound queue entry,
calling the provider API,
writing to the inbox store,
signing the webhook request,
resolving the push token,
or opening the outbound network connection unless the authorization artifact validates and the current authorization decision is the allow decision; and
enforce a non-bypass control in which a non-gateway service identity is prevented from retrieving or using the transport credential by a credential-store access policy or credential-use policy and is prevented from reaching an endpoint of the delivery adapter process by at least one of
a network access control,
a service-mesh policy,
a mutual-TLS service-identity rule,
or a role-based access-control rule.

2. The system of claim 1, wherein the authorization artifact further includes or references
a signature,
a replay-protection value,
a gateway service identity,
a selected delivery adapter identifier,
a provider account identifier,
a delivery authority scope,
and an authorization decision record stored by the routing gateway service.

3. The system of claim 1, wherein the credential-store access policy or credential-use policy prevents
a message-composition service,
campaign service,
content-management service,
administrator console,
or sender API service from retrieving or using at least one of
an SMTP credential,
provider API key,
push-provider credential,
webhook signing key,
inbox-writer credential,
OAuth token,
client certificate,
private key,
session ticket,
delegated bearer token,
service account token,
provider account context,
or other capability required to perform or commit a recipient-visible outbound action.

4. The system of claim 1,
wherein the routing gateway service owns or exclusively controls an outbound delivery queue, and
wherein the outbound delivery queue rejects a delivery job that is submitted by a non-gateway service identity or that lacks the authorization artifact.

5. The system of claim 1, wherein the
network access control,
service-mesh policy,
mutual-TLS service-identity rule,
or role-based access-control rule blocks a non-gateway service from reaching the endpoint of the delivery adapter process unless a request originates from the routing gateway service and carries the authorization artifact.

6. The system of claim 1, wherein the routing gateway service performs an authorization recheck after the proposed outbound communication is queued and before the delivery adapter process
retrieves a transport credential,
uses a cached transport credential,
creates a channel payload,
writes an outbound queue entry,
calls a provider API,
writes to an inbox store,
signs a webhook request,
resolves a push token,
or opens an outbound network connection.

7. The system of claim 6, wherein the authorization recheck changes the current authorization decision to a non-allow decision when, after the proposed outbound communication was received,
the verified sender record has expired or been revoked,
ownership or control of the blockchain-recorded asset or identity has transferred or become unavailable,
the subscription binding record has become inactive,
the opt-in state has changed to an unsubscribe state,
a recipient endpoint has become unavailable,
or a channel policy has changed.

8. The system of claim 1, wherein the delivery adapter process rejects the authorization artifact when the authorization artifact is
absent,
expired,
replayed,
associated with a non-allow decision,
associated with a stale policy version,
or mismatched to any of
the communication identifier,
the recipient identifier,
the channel type,
the verified sender identifier,
a selected delivery adapter identifier,
a provider account identifier,
a provider endpoint identifier,
a queue identifier,
or a delivery authority scope to which the authorization artifact is bound.

9. The system of claim 1,
wherein the cached transport credential comprises
a previously cached,
pre-fetched,
session-derived,
pre-resolved,
or provider-account-scoped transport credential, and
wherein the delivery adapter process is prohibited from using the cached transport credential until the authorization artifact validates for the communication identifier, the recipient identifier, the channel type, and the verified sender identifier.

10. The system of claim 1, wherein the delivery adapter process is an email adapter, and wherein refraining from performing a transport action comprises
not retrieving or using an SMTP credential or provider API key,
not creating an email payload,
not writing an email delivery job to the outbound queue entry,
and not calling an email provider API unless the authorization artifact validates and the current authorization decision is the allow decision.

11. The system of claim 1, wherein the delivery adapter process is a webhook adapter or API callback adapter, and wherein refraining from performing a transport action comprises
not signing the webhook request,
not opening the outbound network connection to a subscriber endpoint,
and not calling the provider API or subscriber API endpoint unless the authorization artifact validates and the current authorization decision is the allow decision.

12. The system of claim 1, wherein the delivery adapter process is a push-notification adapter, and wherein refraining from performing a transport action comprises
not resolving the push token,
not creating a device-targeted payload,
not writing a push-delivery job,
and not calling a push-notification provider unless the authorization artifact validates and the current authorization decision is the allow decision.

13. The system of claim 1, wherein the delivery adapter process is an in-platform inbox adapter or network-delivery adapter, and wherein refraining from performing a transport action comprises
not using an inbox-writer credential,
not writing a message row to the inbox store,
not creating a recipient-visible notification object,
not committing an outbound delivery record,
or not opening the outbound network connection unless the authorization artifact validates and the current authorization decision is the allow decision.

14. A non-transitory computer-readable medium storing instructions that, when executed by one or more processors, cause a system to perform operations comprising:
maintaining a verified sender record generated from cryptographic signature validation and a blockchain ownership or control lookup;
maintaining, in a binding-record data store, a subscription binding record keyed by at least a verified sender identifier and a recipient identifier;
receiving, at a routing gateway service, a proposed outbound communication associated with the verified sender record and the recipient identifier;
determining a current authorization decision for the recipient identifier from at least the verified sender record, the subscription binding record, an opt-in state, a channel type, and a policy version;
only when the current authorization decision is an allow decision, generating an authorization artifact comprising either a signed authorization token or a gateway-generated authorization decision identifier that uniquely identifies an authorization decision record stored by the routing gateway service, the authorization artifact being bound to at least
a communication identifier,
the recipient identifier,
the channel type,
the verified sender identifier,
a binding identifier,
the policy version,
an issued-at time,
an expiration time,
and a nonce;
causing a delivery adapter process to validate the authorization artifact before the delivery adapter process
retrieves a transport credential,
uses a cached transport credential,
creates a channel payload,
writes an outbound queue entry,
calls a provider API,
writes to an inbox store,
signs a webhook request,
resolves a push token,
or opens an outbound network connection;
preventing the delivery adapter process from
retrieving the transport credential,
using the cached transport credential,
creating the channel payload,
writing the outbound queue entry,
calling the provider API,
writing to the inbox store,
signing the webhook request,
resolving the push token,
or opening the outbound network connection when the current authorization decision is not the allow decision or when the authorization artifact fails validation; and
enforcing a non-bypass control that prevents a non-gateway service identity from retrieving or using the transport credential and from reaching an endpoint of the delivery adapter process.

15. A computer-implemented method for controlling replay of a failed outbound communication, the method comprising:
after a first delivery attempt for a communication identifier and a recipient identifier has failed or has not completed, storing, by one or more processors, a queue item in a retry queue or a dead-letter queue, the queue item being associated with the communication identifier, the recipient identifier, and an initial authorization artifact used for the first delivery attempt, the initial authorization artifact comprising an initial authorization token or an initial gateway-generated authorization decision identifier;
receiving, at a routing gateway service, a replay request or redrive request for the queue item;
in response to the replay request or redrive request, generating, after the failed or incomplete first delivery attempt, a new authorization decision for the recipient identifier by rechecking current verified-sender state, current binding-record state, current opt-in state, current endpoint state, and current channel policy;
only when the new authorization decision is an allow decision, generating a fresh authorization artifact comprising a fresh authorization token or a fresh gateway-generated authorization decision identifier, the fresh authorization artifact being distinct from the initial authorization artifact;
marking the initial authorization artifact as replay-ineligible for the replay request or redrive request after the failed or incomplete first delivery attempt;
rejecting reuse of the initial authorization artifact for the replay request or redrive request;
requiring a delivery adapter process, before
retrieving a transport credential,
using a cached transport credential,
creating a channel payload,
writing an outbound queue entry,
calling a provider API,
writing to an inbox store,
signing a webhook request,
resolving a push token,
or opening an outbound network connection for the replay request or redrive request,
to validate the fresh authorization artifact;
and refraining from
retrieving the transport credential,
using the cached transport credential,
creating the channel payload,
writing the outbound queue entry,
calling the provider API,
writing to the inbox store,
signing the webhook request,
resolving the push token,
or opening the outbound network connection for the replay request or redrive request unless the fresh authorization artifact validates and the new authorization decision is the allow decision.

16. The method of claim 15, wherein the fresh authorization artifact differs from the initial authorization artifact by at least one of
an artifact identifier,
decision timestamp,
issued-at time,
expiration time,
nonce,
replay-protection value,
policy version,
binding-record state,
signature,
selected delivery adapter identifier,
provider account identifier,
provider endpoint identifier,
queue identifier,
or delivery authority scope.

17. The method of claim 15,
wherein the queue item stores the initial authorization artifact for audit or failure-classification use, and
wherein the delivery adapter process is configured to reject the initial authorization artifact for the replay request or redrive request even when the initial authorization artifact was valid or unexpired for the first delivery attempt.

18. The method of claim 15, wherein the new authorization decision is a non-allow decision when, after the first delivery attempt,
the verified sender record has expired or been revoked,
ownership or control of a blockchain-recorded asset or identity has transferred or become unavailable,
a subscription binding record has become inactive,
an opt-in state has changed to an unsubscribe state,
a recipient endpoint has become unavailable,
or a channel policy has changed.

19. The method of claim 15,
wherein the queue item is one of a plurality of failed delivery items for a plurality of recipient identifiers, and
wherein the routing gateway service generates a separate new authorization decision and a separate fresh authorization artifact for each recipient identifier before replaying or redriving a corresponding failed delivery item.

20. The method of claim 15, further comprising enforcing a gateway-authorized redrive path in which a non-gateway service identity is prevented from
reading the queue item from the retry queue or dead-letter queue,
writing the queue item to an outbound delivery queue,
retrieving or using a transport credential,
or reaching an endpoint of the delivery adapter process unless the routing gateway service has generated the fresh authorization artifact.
